(19) United States
(12) Patent Application Publication
(10) Pub. No.: US 2008/0179157 A1
(43) Pub. Date: Jul. 31, 2008

(54) CLUTCH UNIT

(75) Inventors: Bin Zhou, Buhl (DE); Markus Zufle, Buhl (DE)

Correspondence Address: ALFRED J MANGELS, 4729 CORNELL ROAD, CINCINNATI, OH, 452412433, US

(73) Assignee: Luk Lamellen und Kupplungsbau Beteiligungs KG, Buhl (DE)

(21) Appl. No.: 12/006,067

(22) Filed: Dec. 28, 2007

Related U.S. Application Data
(63) Continuation of application No. PCT/DE2006/001100, filed on Jun. 27, 2006.

(30) Foreign Application Priority Data
Jun. 28, 2005 (DE) 10 2005 030 503.2
Jun. 28, 2005 (DE) 10 2005 030 504.0
Jun. 13, 2006 (DE) 10 2006 027 641.8

(51) Int. Cl. F16D 21/00

(52) U.S. Cl. 192/48.1

(57) ABSTRACT

A clutch unit including at least two sub-units, one of which is pre-assembled on the engine side of a motor vehicle drive train, namely on the output shaft of the engine, and the other sub-unit is pre-assembled on the transmission side of the drive train. The pre-assembled sub-units each include respective interengaging teeth to provide a positive drive connection therebetween.

### CROSS-REFERENCE TO RELATED APPLICATION

This is a continuation of International Application Serial No. PCT/DE2006/001100, with an international filing date of 27 Jun. 2006, and designating the United States, the entire contents of which is hereby incorporated by reference to the same extent as if fully rewritten.

### BACKGROUND OF THE INVENTION

1. Field of the Invention

The present invention relates to a clutch unit or clutch system including at least two sub-units, one sub-unit connectable to the output shaft of an engine and the other sub-unit that is pre-assembled and connectable on the transmission side, wherein the two units can be coupled to one another via an axial plug-in connection that includes interengaging teeth.

2. Description of the Related Art

Clutch units that are divided into two sub-units and that are coupled with each other as part of a drive train only when the transmission and engine are assembled have been proposed by German Patent Publication No. DE 10 2005 037514 A1 and by German Patent Publication No. DE 10 2005 027608 A1, for example.

An object of the present invention is to provide a connection between the two sub-units that ensures correct transfer of torque and that can be produced by simply fitting the two parts together axially. The connection in accordance with the present invention is intended to prevent striking or rattling noises, in particular those due to torsional vibrations, wobbling vibrations, and axial vibrations of components.

### SUMMARY OF THE INVENTION

In accordance with the present invention, the object is achieved, at least in part, by at least individual tooth-shaped profiles that form profiles and counter-profiles that are biased in the circumferential direction by means of a biasing element. The biasing element has at least individual profiles and is supported indirectly or directly by one of the components that includes the profiles or counter-profiles of the plug-in connection, and is biased against the latter in the circumferential direction by means of at least one energy storage device. The biasing element profiles mesh with profiles or counter-profiles of the component by which it is not supported, wherein at least after the axial plug-in connection is made the profiles of the biasing element and the profiles or counter-profiles of the component that supports the latter are biased in opposite directions in the circumferential direction. Such opposed biasing in the circumferential direction ensures a biasing within the axial plug-in connection in at least one direction of relative rotation between the two sub-units. That biasing can be accomplished in an advantageous manner in such a way that the profiles and counter-profiles are biased in the pulling direction, i.e., so that during biased operation flanks of the profiles and counter-profiles that are responsible for transferring torque are in contact with each other. However, for some application cases it can also be useful for the biasing to be accomplished by having the profiles and counter-profiles biased in the pushing direction. Pulling mode or pulling direction means the operating state of a motor vehicle in which the engine is propelling the motor vehicle, i.e., the engine is introducing torque into the transmission. In the pushing mode the motor vehicle is braked by the engine, or by an introduction of torque into the engine by means of the drive wheels.

Although the pre-assembled sub-unit on the transmission side can have only a single clutch, it is especially useful for many applications if that sub-unit has a double clutch. The two clutches can then have a common intermediate pressure plate, i.e., they can be situated axially on both sides of such an intermediate pressure plate. Such an intermediate pressure plate can advantageously be supported centered on a transmission input shaft.

In an advantageous manner, the sub-unit on the engine side can include a torsional vibration damper.

The spring means that ensure angular positioning of the profiles and counter-profiles can produce a torsional stiffness that can be of a magnitude between 10 and 60 Nm/°. For some applications it can also be useful for the torsional stiffness to be designed to be even larger.

The biasing element can advantageously be of an annular design and can have only individual profiles distributed around the circumference. It can be especially useful for the biasing element to have a plurality of groups of profiles, which are preferably uniformly distributed about the circumference. The profiles of the biasing element can be designed in a simple manner as tooth-like forms or clip-like projections. It can be especially useful for producing the axial plug-in connection if the biasing element and the component that carries it directly or indirectly, which has profiles or counter-profiles, are held in a defined angular position before the plug-in connection is made, at least by means of one locking element, against the effect of the at least one energy storage device, which allows the axial plug-in connection to be made practically without force by fitting the profiles and counter-profiles together axially. In an advantageous manner, the at least one locking element can be designed in a single piece with the biasing element. Such a locking element can be formed, for example, by at least one elongated tongue extending in the circumferential direction, and which includes an axially movable end that bears against a supporting region of a component that carries the biasing element. The supporting region in this case can be formed by a tooth flank of a profile or counter-profile. However, such a supporting region can also be provided outside of the profiles or counter-profiles.

### BRIEF DESCRIPTION OF THE DRAWINGS

The invention will be explained in greater detail on the basis of the drawing figures, in which:

FIG. 1 is a longitudinal half-sectional view through a clutch unit including a plug-in connection,

FIG. 2 is a fragmentary, enlarged representation of the plug-in connection shown in FIG. 1,

FIG. 3 shows the assembly of components by which the biasing between the profiles and counter-profiles is realizable,

FIGS. 4 and 5 show connection details of the component arrangement shown in FIG. 3, and

FIGS. 6 and 7 show a variant version of the connection details shown in FIGS. 4 and 5.

### DESCRIPTION OF THE PREFERRED EMBODIMENTS

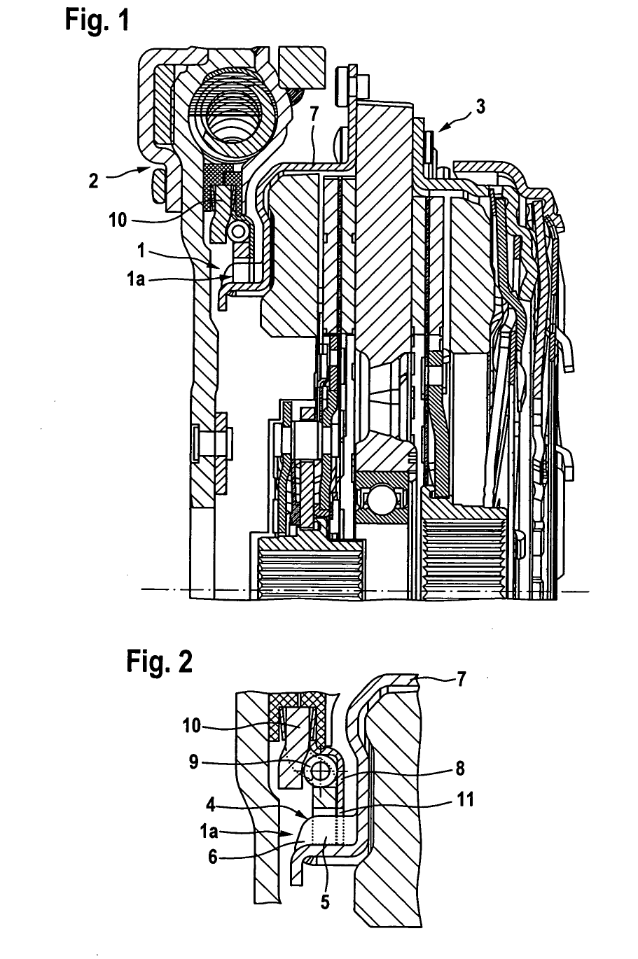

In FIG. 1 a drive connection 1 is shown that is designed as an axial plug-in connection 1a. Through axial plug-in connection 1a it is possible to join together two sub-units 2 and 3, of which sub-unit 2 includes a torsional vibration damper that can be connected to an output shaft of an internal combustion engine, and sub-unit 3 in the illustrated exemplary embodiment includes a double clutch which is pre-assemblable on the transmission side.

As can be seen in FIG. 2, axial plug-in connection 1a is made by a toothed connection 4 which includes tooth profiles 5 and 6 that mesh with each other. In the illustrated exemplary embodiment, the tooth profiles 5 are carried by a flange-like output element 10 of the torsional vibration damper of sub-unit 2, and the tooth profiles 6 are carried by a drive ring 7, which is part of the sub-unit 3 that is pre-assembled on the transmission side. The tooth profiles 5 form an inner tooth arrangement, whereas the tooth profiles 6 form a correspondingly matched outer tooth arrangement.

To ensure circumferential biasing of the tooth profiles 5 and 6, a biasing element 8 is provided which is acted on in the circumferential direction by at least one energy storage device 9, which is shown as a helical compression spring. Energy storage device 9 can also be designed differently, however. For example, the biasing element 8 shown in annular form can have bending-beam-type arms, which can be elastically pre-stressed and produce a peripheral force at least on output element 10. Such arms can be biased against output element 10 with appropriate pre-stress. Energy storage device 9 is installed between output element 10 and biasing element 8 and is biased in the circumferential direction.

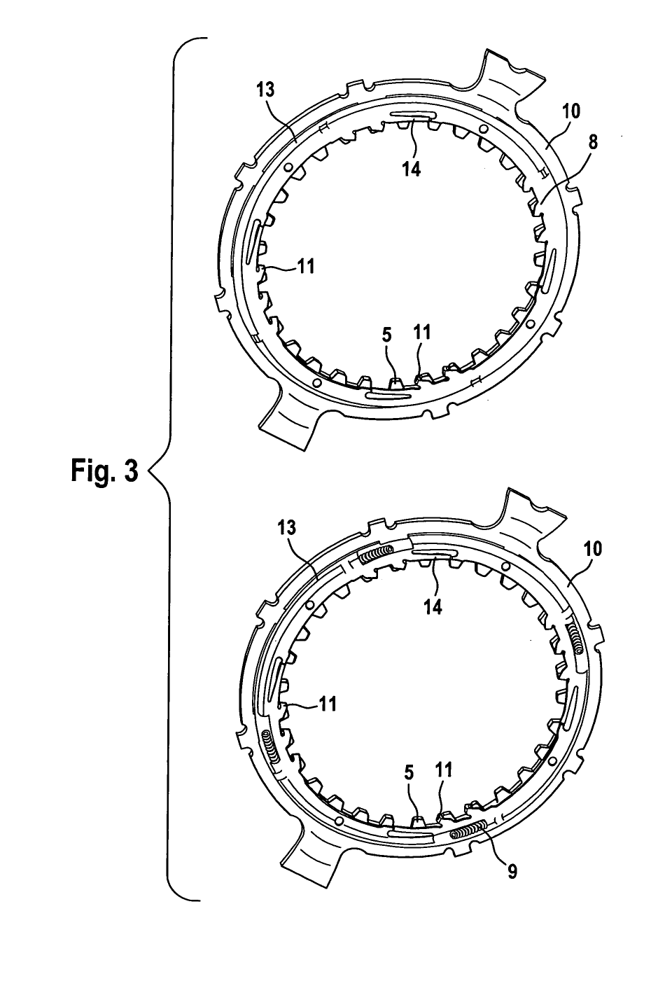

As can be seen in FIGS. 3 through 5, biasing element 8 forms or carries at least individual profiles or regions 11, which are suitable for interacting with profiles or teeth of tooth profile 6 by coming to bear with pre-biasing against flanks of such profiles or teeth.

In the illustrated exemplary embodiment, the regions 11 initially form axially running sections 12, which emerge from the annular main body 13 of biasing element 8. On the side of the output element 10 having the tooth profiles 5 opposite the annular main body 13, the sections 12 transition to a U-shaped clip 13a extending in the circumferential direction. The clips 13a ensure an axial connection between the two components 8 and 10.

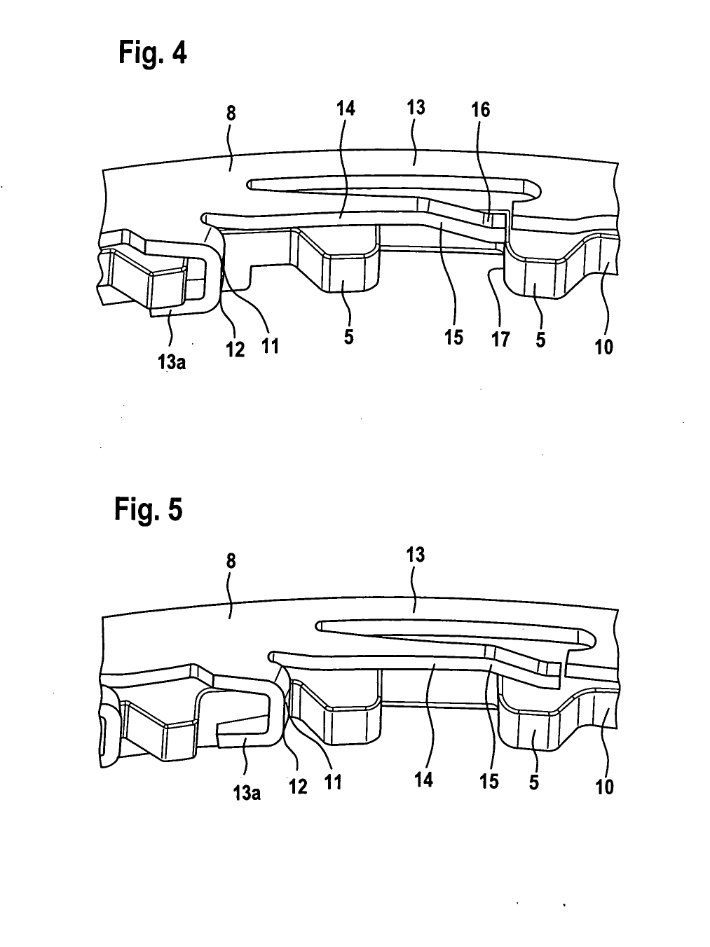

Before and while the plug-in connection 1a is made, biasing element 8 is secured against the circumferential biasing force produced, for example, by means of energy storage devices 9, in an angularly retracted position opposite the tooth profiles 5. That retracted position ensures that the tooth profiles 5 and 6, which form the drive connection, can be freely pushed axially toward each other. As can be seen from FIGS. 4 and 5, that angularly retracted position of biasing element 8 is ensured by at least one locking element or locking region 14. The locking region 14 is formed in the illustrated exemplary embodiment by an axially deformable, preferably elastically designed tongue 15, which is designed here in a single piece with the annular biasing element 8 and extends at least substantially in the circumferential direction. Before and during assembly of the drive connection 1 formed by plug-in connection 1a, the free end 16 of the tongue 15 bears against the component 10; in the illustrated exemplary embodiment that occurs on a side flank 17 of a tooth profile 5. However, at least one special supporting region can also be provided for tongue 15 on component 10.

While the drive connection 1 is being made, or only afterward, the locking element 14 or the tongue 15 is forced into a position, or is sprung back because of inherent elasticity into a position that causes the biasing element 8 to be rotated in relation to component 10 as a result of the pre-biasing of the energy storage device 9. Because of that rotation, the regions 11 or the axial portions 12 of those regions come into contact with a flank of a profile 6, and in consequence the tooth profiles 5 and 6 are biased circumferentially. The reversal of the locking between the two components 8 and 10 shown in FIG. 4 can take place in an advantageous way after assembly or after the drive connection 1 is made. That can be effected by starting up the internal combustion engine, which transmits torsional vibrations to the clutch unit. The torsional vibrations produced by the moment fluctuations cause the sections 12 to be rotated at least slightly in relation to component 10, against the pre-biasing of the at least one spring 9, whereby the circumferential support or locking between the free end 16 of the tongue 15 and the side flank 17 of a tooth profile 5 is reduced or released. As a result, the axially resilient tongue 15 can spring back into an unlocking position, which is shown in FIG. 5.

However, the intermeshing tooth profiles 5, 6 or the components 8 and 10 can also be designed so that when the two sub-units 2 and 3 are fitted together the tongues 15 are forcibly pushed into the position shown in FIG. 5. With such a configuration, the tongue 15 can then also have a non-biased position, which corresponds to FIG. 4, and while the drive connection 1 or the plug-in connection is being made it can be pushed into the axial position shown in FIG. 5.

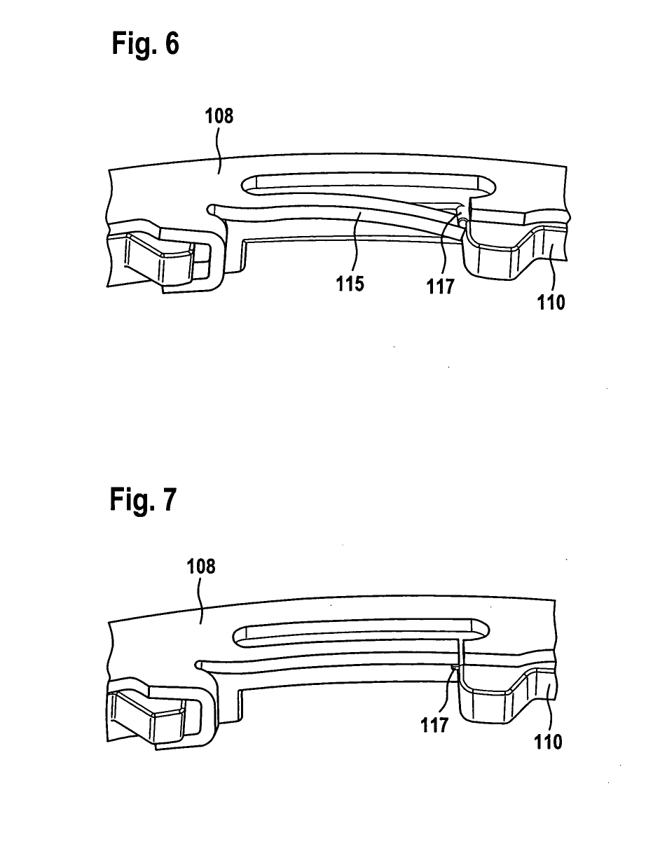

Referring to FIGS. 6 and 7, if the two components 8 and 10 are unlocked only by starting up the internal combustion engine or motor, it can be useful if a restraining region or an axial support lobe 117 is provided, which restrains the correspondingly elastically pre-biased tongue 115. That ensures that even during transporting, an unlocking of a biased condition between the two components 108 and 110, for example due to shocks or other influences, is reliably prevented. Only when the component 108 is rotated appropriately in relation to the component 110 does the support lobe 117 release the axially elastically pre-biased tongue 115, so that the latter can assume the position shown in FIG. 7. In that position the arresting or locking between the two components 108 and 110 is released, so that the biasing moment produced by the energy storage device 9 causes a circumferential biasing of the toothed connection 4 or of the tooth profiles 5 and 6.

What is claimed is:

1: A clutch unit for a drive train including an engine and a transmission, said clutch unit comprising: at least two sub-units, a first sub-unit connectable to an output shaft of an engine and a second, pre-assembled sub-unit connectable to the transmission side, wherein the first and second sub-units are coupled to one another via an axial plug-in connection that includes intermeshing tooth-shaped profiles and counter-profiles; wherein at least individual ones of the tooth-shaped profiles and counter-profiles are biased in a circumferential direction of the clutch unit by means of a biasing element, the biasing element having at least individual profiles and being supported by an element that includes one of profiles and counter-profiles of the plug-in connection and being biased against an opposed element in the circumferential direction by means of at least one energy storage device, and having its profiles mesh with profiles or counter-profiles of the opposed element, where at least after the axial plug-in connection is effected the profiles of the biasing element and the profiles or counter-profiles of the opposed element are circumferentially biased in opposite directions.

2: A clutch unit in accordance with claim 1, wherein the second sub-unit includes a double clutch and is supported centered on a transmission input shaft.

3: A clutch unit in accordance with claim 1, wherein the first sub-unit includes a torsional vibration damper.

4: A clutch unit in accordance with claim 1, wherein the biasing element includes spring means for producing a biasing force within the axial plug connection which produces a torsional stiffness on the order of magnitude of between 10 and 60 Nm/°.

5: A clutch unit in accordance with claim 1, wherein the biasing element is of annular form and includes a plurality of groups of profiles distributed circumferentially.

6: A clutch unit in accordance with claim 5, wherein the groups of profiles form a plurality of tooth-like projections.

7: A clutch unit in accordance with claim 1, wherein the biasing element and a supporting component that includes one of profiles or and counter-profiles, are held in a defined angular position before the plug-in connection is made, at least by means of one locking element, against the effect of the at least one energy storage device to allow the axial plug-in connection to be made without force by fitting the profiles and counter-profiles together axially.

8: A clutch unit in accordance with claim 7, wherein the locking element is integrally formed with the biasing element.

9: A clutch unit in accordance with claim 7, wherein the locking element is formed by at least one elongated tongue extending in the circumferential direction, which at least one tongue includes an axially movable end that bears against a supporting region of a component that carries the biasing element.

10: A clutch unit in accordance with claim 8, wherein the support region is formed by a tooth flank of a profile or counter-profile.
